(19) United States
(12) Patent Application Publication
(10) Pub. No.: US 2022/0144684 A1
(43) Pub. Date: May 12, 2022

(54) JET SYSTEM FOR JETTING LAMINATED GLASS PANELS OF DIFFERING WIDTHS

(71) Applicants: Heraeus Noblelight GmbH, Hanau (DE); LISEC Austria GmbH, Seitenstetten (AT)

(72) Inventors: Bernhard WEBER, Hanau (DE); Leopold FEHRINGER, Seitenstetten (AT); Jacob GANGL, Seitenstetten (AT)

(21) Appl. No.: 17/284,921

(22) PCT Filed: Oct. 17, 2019
(86) PCT No.: PCT/EP2019/078144

§ 371 Date: Apr. 13, 2021

(30) Foreign Application Priority Data
Oct. 19, 2018 (EP) 18201450.6

(51) Int. Cl. C03B 33/07

(52) U.S. Cl. CPC C03B 33/078

(57) ABSTRACT

An emitter system for the irradiation of laminated glass panels of different widths, a glass cutting device for processing laminated glass panels of different widths with such an emitter system, a manufacturing method for such an emitter system, and a use of such an emitter system for the irradiation of laminated glass panels of different widths. The emitter system includes a plurality of elongated emitters. The elongated emitters are arranged one behind the other on a common longitudinal axis. The elongated emitters each have two ends, which are angled in relation to the common longitudinal axis. The emitter system is arranged in a glass cutting device.

### CROSS REFERENCE TO RELATED APPLICATIONS

This application is a U.S. National Phase filing of International Patent Application No. PCT/EP2019/078144 filed on Oct. 17, 2019, which claims the priority of European Patent Application No. 18201450.6 filed on Oct. 19, 2018. The disclosures of these applications are hereby incorporated by reference in their entirety.

### TECHNICAL FIELD

The present disclosure relates to an emitter system for the irradiation of laminated glass panels of different widths, a glass cutting device for processing laminated glass panels of different widths with such an emitter system, a manufacturing method for such an emitter system and a use of such an emitter system for the irradiation of laminated glass panels of different widths.

A laminated glass panel can be a composite or stack of a glass sheet, a plastic film and possibly a further glass sheet. The plastic film can be a composite film. A composite film can be composed of several layers of plastic. A composite film can also be called a laminated plastic film.

The emitter system can be a sequential infrared heater for heating and softening or also cutting the film in the composite glass panel. The glass cutting device can be a glass cutting bench for the machine processing of glass.

### BACKGROUND

Laminated glass panels or laminated safety glass (LSG) panels are produced from sheets of glass with dimensions of, for example, 3.2×6 meters, although smaller or larger sizes are available. The laminated glass panels must be cut on laminated glass cutting machines to the required formats, for example for the production of glass panes for windows, construction elements and other components. Alternatively, laminated glass panels can be produced from glass sheets with dimensions of 1.5×3 meters or 2.5×3 meters for example. In order to cut laminated glass panes to the appropriate format, an upper and and a lower glass sheet are scored, for example, a breaking roller is moved under pressure over the glass sheet along the score line in order to break the lower glass sheet and the upper glass plate is then broken by bending downwards so that a continuous crack is produced. Along the fracture line the glass sheets are then pulled apart, whereby the film is heated with a heating device and then cut through with a knife.

Conventional heating devices extend over the entire width of the glass cutting bench, for example six meters. The heating devices are switched on after scoring and bending the laminated glass pane in order to irradiate the plastic film along the score line and to produce a separation gap through the effect of the tensile force acting on the parts of the sheet. If considerably shorter laminated glass panels are processed on such a glass cutting device, unavoidably the entire length of the emitter is nevertheless switched on, so that in the case of smaller formats, heat energy and heating up time are lost. Furthermore, due to permissible current and voltage being restricted to approximately 16 to 20 A and approximately 400 to 700 V, respectively, such a heating device can have a current density of only 20 to 25 W/cm². However, the current density should be increased in order to be able to shorten the irradiation duration.

Document WO 2015/117172 A1 discloses a method of separating laminated glass. To divide a laminated glass sheet into laminated glass panes, in the area of the dividing line, through the local application of heat thermal stresses are produced in the glass of the glass sheets so that, if required, through additional force effect the laminated glass sheet is divided into two laminated glass panes. For local heating, more particularly extending over the entire length of the dividing line, heating elements emitting infrared or laser rays can be used. The heating elements are preferably provided on both sides of the laminated glass sheet.

Document WO 2015/081351 A1 discloses a method and a device for heating films in the laminated glass. When heating films in the laminated glass, when separating, and in order to melt off or soften a film, heat rays, more particular infrared rays, are directed onto the film by a heating element. The heat rays are bundled by a reflector assigned to the heating element. The heat rays passing through the laminated glass and the film are reflected in the direction of the film by a further reflector located on the side of the laminated glass opposite the heating element.

EP 2 942 330 A1 discloses a device for cutting and dividing glass panels with a supporting device for supporting a glass panel in an essentially horizontal position. The glass panel has an upper and a lower surface. The device comprises a positioning bridge with a horizontally extending positioning section which is arranged at a vertical distance from the lower or upper surface of the glass panel and the supporting device, while a cutting mechanism, arranged on the positioning section, comprises a cutting element that is moveable along the positioning section and over the upper or lower surface of the glass panel in order to cut the relevant surface in such a way that a linear scoring line is obtained. The positioning section is also provided with a dividing device for dividing the glass panel into two separate glass panels along the linear scoring line. The dividing device is configured such that it moves along the positioning section and along the linear scoring line while exerting a controlled pressure, which varies in a pulsating manner, on the glass panel along the linear scoring line.

Document EP 2 783 785 A1 discloses a method of cutting flat glass. The flat glass is broken along at least one predetermined cutting line in that a scoring line coincides with the cutting line on at least one of the surfaces of the flat glass, and heat emitted from an electric bulb is directed onto the scoring line through which a breakage front is produced at one point on the scoring line and the heat beam is moved along the breakage front in order to bring about continuous advancing of the breakage front along the scoring line.

EP 1 323 681 A2 discloses a method of dividing laminated glass sheets, wherein a laminated glass sheet is scored along a desired dividing line and the laminated glass sheet is then broken along the scored dividing line, after which a heating device is used to expose film material in the area of the dividing line of the laminated glass sheet to heat by way of a heat-emitting device. A heating device is used that, depending on the length of the dividing line, heats the dividing line area over a corresponding heating length.

DE 101 64 070 B4 discloses a device for dividing laminated glass sheets comprising a device for scoring and breaking the laminated glass sheets, as well as a heating device, which heats film material in the area of a dividing line of a laminated glass sheet via a heat-emitting device. The heat-emitting device for the sectional heating of glass panels of different widths, comprises a plurality of heat emitters of different lengths.

EP 3 208 245 A1 discloses a device and method for cutting a laminated glass panel. A laminated glass panel with two glass sheets and an intermediate film made of thermoplastic material is cut on a cutting machine provided with a breaking device in order to divide the laminated glass panel into two parts which are connected to each other by an elongated intermediate section of the film. The device also comprises a heating device for heating the elongated intermediate section, wherein the heating device is provided with a light bulb which is borne by a carriage of the breaking device.

Document DE 1919 673 A1 discloses a method and a device for thermally breaking glass.

WO 02/23591 A1 discloses a radiation source for electromagnetic radiation for producing an elongated irradiation zone, wherein the essentially active portion of the radiation source is in the near infrared range, more particularly in wavelength ranges of between 0.8 μm and 1.5 μm. The radiation source comprises an elongated halogen lamp which has a tube-shaped glass body with sockets at the ends, with at least one light bulb, and an elongated reflector.

WO 02/054452 A1 discloses a thermal treatment device. A plurality of double-ended lamps heat the object to be processed in order to apply a thermal treatment procedure on the object. Several reflectors reflect radiated heat of the double-ended lamps onto the object to be processed. Each of the double-ended lamps has a linear light-emitting section. At least two double-ended lamps of the several double-ended lamps are arranged along a longitudinal direction of the light-emitting section. The plurality of double-ended lamps are arranged in such a way that the light-emitting sections are in parallel to each other and positioned in at least two steps.

EP 2 003 677 A2 discloses a filament lamp with a plurality of filament devices. DE 1 589 271 A discloses an electric light bulb. U.S. Pat. No. 5,600,205 discloses a curved lamp. DE 1 929 622 A discloses an elongated electric light with a curved end. DE 297 02 002 U1 discloses a light source device for a scanner. DE 198 22 829 A1 discloses a shortwave, infrared surface heater in which several infrared emitters connected to each other to form a common emitter plane are arranged adjacent to and in parallel with each other. DE 84 34 317 discloses an irradiation unit in the form of a portal, in particular as a drying and burn-in channel for the automotive industry.

### SUMMARY

An object of the present disclosure is to provide an emitter system for the irradiation of laminated glass panels of different widths and/or thicknesses which uses less energy than conventional systems.

This object is achieved by an emitter system for the irradiation of laminated glass panels of different widths, a glass cutting device for processing laminated glass panels of different widths with such an emitter system, a manufacturing method for such an emitter system and a use of such an emitter system for the irradiation of laminated glass panels of different widths in accordance with the following disclosure. Advantageous forms of embodiments and further developments are set out in the following description.

An emitter system in accordance with the present disclosure for the irradiation of laminated glass panels of different widths comprises several, more particularly at least three, elongated emitters. The elongated emitters are arranged one behind the other on a common longitudinal axis. The elongated emitters each have two ends, which are angled in relation to the common longitudinal axis. The emitter system is arranged in a glass cutting device.

The laminated glass panel or laminated safety glass panel can be a composite or stack of, for example, two glass sheets and a plastic film interspersed between them. The laminated glass panel can also comprise further layers.

The emitter system can be an infrared heater for heating and softening or also cutting through and/or dividing the film in the composite glass panel. The emitter can, in particular, emit shortwave infrared radiation, preferably in the range between 0.8 and 1.5 μm. The film is heated for dividing the laminated glass panel. In accordance with one embodiment, the film can be heated through heating to below a film melting temperature and above a film softening temperature. Parts of a laminated glass panel can then be separated from each other with little resistance from the plastic film. In accordance with another embodiment, the film can be heated through heating to above a film melting temperature. In the latter case, in a focusing area of the emitter there is practically no more film present after melting. Parts of a laminated glass panel can then be separated from each other without resistance from the plastic film. The plastic film can have a thickness of at least 0.2 mm and/or at most 10 mm, more particularly of at least 0.38 mm and/or at most 3.8 mm or at most 4.56 mm. The glass cutting device can be a glass cutting bench for the machine processing of glass.

The term “elongated emitters” means that the emitters are longer than they are wide. In one form of embodiment the elongated emitters are each of equal length. They are arranged geometrically one after the other in series. The emitters can be activated and controlled independently of each other and therefore can be electrically connected in parallel. The emission direction of the emitters is essentially perpendicular to a laminated glass panel to be irradiated. The emitters can be arranged along a width of a laminated glass panel to be irradiated and perpendicularly to a conveying direction of the laminated glass panel.

The ends or arms of the individual emitters are angled in relation to the common longitudinal axis so the power connections are not located in the plane of the emitters. More particularly, relative to the longitudinal axis of the emitters, the arms of the emitter point away from the working plane in which a laminated glass panel to be processed extends. “Angled” is taken to mean that a curvature of the emitter is brought about, not an angular shape of the emitter. Through being angled or bent outwards, the sensitive ends of the emitters are protected from being exposed to heat by the emitters, which increases their service life. Moreover, homogenous and continuous irradiation through the plurality of emitters is achieved.

Through at least three emitters being arranged along a common longitudinal axis, only as many emitters are used as is necessary for the current component width or processing length. Preferably between 3 and 10 emitters are used. Because of the higher number of emitters compared with the prior art, the length of the individual emitters can be reduced. Shorter emitters are considerably easier to use than longer ones. Furthermore, in contrast to the prior art, a 6 meter-long emitter is not used to irradiate a component that is, for example, 1.5 meters long. In this way, considerable energy and time savings can be achieved.

In one form of embodiment the two ends of the emitters are angled, in the sense of being bent towards, at an angle of between 50 and 140° in relation to, the common longitudinal axis. Preferably, they are angled at an angle of between 80 and 100° and more preferably by 90°. In this way the power connections can be directed out of the plane of the emitters and upwards, for example. The power connections can thus be located outside the direct irradiation and remain cooler, which increases their service life.

In one form of embodiment, the emitter system comprises between 3 and 10 elongated emitters. Preferably, the emitter system comprises between 6 and 8 elongated emitters, even more preferably 7 emitters. The number of individual emitters is higher than usual, so that the right number and right selection of emitters can be chosen to match each specific component precisely.

The emitters can be round tube emitters.

The emitters can be designed as double tube emitters wherein only one of the tubes is fitted with a heating coil. Through the double-tube configuration, the emitter is mechanically stabilized in a similar way to an H beam.

More particularly, the emitters have a length of at least 200 mm or 300 mm and/or at most 1,200 mm or at most 1,500 mm. In one form of embodiment, the emitters have a length of at least 400 mm and/or at most 500 mm. In accordance with one form of embodiment, the emitters have a length of at least 850 mm and/or at most 950 mm. Particularly preferred are emitters with a length of approximately 450 mm and emitters with a length of approximately 950 mm. When looking at the free ends of the arms of the emitter from above, the aforementioned lengths are measured from a midpoint of the free end of one arm of the emitter to the midpoint of the free end of the other arm of the emitter. In one form of embodiment the elongated emitters are each of equal length. The emitter length is considerably shorter than the, for example, 6 meter-long emitters of the prior art. With the emitter lengths according to the invention, common glass formats and cutting lengths of approximately 3,300 mm; 3,700 mm; 4,700 mm and 6,100 mm can be precisely processed with little or no irradiation beyond the component size. In this way, energy is saved and the heat input into the component and resulting damage to the material is reduced. Also, the component is not so strongly heated that it can no longer be positioned by hand. Additionally, transporting, assembly and the overall handling of the emitters are made easier through their smaller length. In accordance with one embodiment, the emitter system exclusively comprises emitters of the same length. According to another embodiment, the emitter system comprises at least two emitters of different lengths.

In one form of embodiment each emitter has a length which is smaller than the width of a laminated glass panel to be irradiated. Due to the reduced length of the emitter system compared with the prior art, in contrast to the prior art a high current with excess voltage through special connections and a transformer do not have to be provided. Instead, the emitter system can be operated with a normal voltage of (nominally) 230 V and a frequency of 50 Hz and achieve a power of up to 45 W radiated power per centimeter of emitter length. The emitters of the prior art only achieve up to 25 W radiated power per centimeter of emitter length.

In one form of embodiment the emitters each comprise a heating coil or filament which is suitable for heating and softening a plastic film inside a laminated glass panel. The heating coil can also be designed so that the emitter can sever the plastic film through the heat input of the heating coil, more particularly in such a way that the glass panels can be divided without an additional separating tool. The plastic film can have a thickness of at least 0.2 mm and/or at most 10 mm, more particularly of at least 0.38 mm and/or at most 4.56 mm.

In one form of embodiment, the angled ends or arms of the emitters have a bending radius in relation to the common longitudinal axis and the heating coils in the emitters extend along the common longitudinal axis and beyond the vertices of the bending radii. “Angled” is taken to mean a curvature, not an angled shape of the emitter. The “bending radius” refers to the curvature the emitter has after being angled in the sense of bending outwards. The “vertex” is the point on the angle and curved emitter at which the curve has a local extreme point, here a local minimum. The bending radius can be between R20 and R30. A person skilled in the art knows that “Rx” denotes a bending radius by way of a constant bending radius “x” along a curve in mm in relation to an imaginary curvature midpoint of the bending radius. By “pulling in” the heating coil into the bending radii and beyond, homogenous irradiation of the component along the plurality of emitters is achieved and possibly inhomogeneity in the transition between two adjacent emitters is reduced or avoided.

In this form of embodiment, the heating coil ends after the two vertices but still before the ends of the arms of the emitter. These arm ends, which can comprise connection elements of the emitter, therefore do not have heating coils and accordingly are not directly heated. In other words, the incandescent area of the heating coil only begins at a certain distance from the unheated arm ends of the emitter. This distance can be between 60 and 90 mm. The distance can be 75 mm for example. These figures can relate to an arm between 90 and 120 mm long and, in particular, to a 107 mm long arm. Through leaving the arm ends of the emitter free of the heating coil, the electrical connection elements on the arm ends are protected from heat and thereby their service life is increased. The upper limits of the distances stated here result from the installation space of the emitter which is usually limited by, for example, cutting devices and conveying devices.

The individual emitters and/or their heating coils can be controlled and, in particular, can be switched on and off independently of each other. It is also possible to identify a component and its dimensions (for example with a label, for example an RFID tag) or measure it (by laser, for example), and as a function thereof switch on and off a suitable number and selection of emitters, or regulate their strength.

In one form of embodiment the power density of the emitter system is between 30 and 50 W/cm2. Preferably, the power density of the emitter system is between 40 and 50 W/cm2. In conventional emitters, only considerably lower power densities can be achieved. Through the high power density of the emitter system, a shorter irradiation duration can be made possible, which reduces heating and thermal damage of the plastic film remaining in the surrounding laminated glass. The irradiation or heating duration is dependent on the film thickness and can be between approximately 5 seconds and 40 seconds. Theoretically, power densities of around 200 W/cm2 are also possible.

In one form of embodiment, at least one of the emitters comprises a light exit slit and a reflector. The light exit slit in the emitter remains free to emit radiation in the direction of the laminated glass panel. The reflector can reflect radiation emitted by the emitter in the direction of the reflector back in the direction of the light exit slit. The reflector can be a coating, in particular a gold coating, on the periphery of the emitter. Alternatively or additionally, the reflector can also be made of aluminium or a porous quartz glass (for example Heraeus QRC® “Quartz Reflective Coating”). The reflector can enable focusing of the radiation onto as narrow a line as possible along the plastic film in the laminated glass and thereby produce as narrow a heating or melting area as possible. In this way, the power density of the emitter can be reduced. In addition, the reflector prevents or reduces heating of the emitter periphery, the surrounding components of the glass cutting device and the laminated glass panel outside the cutting line.

The emitters can each have a diameter of between 1 and 2 cm. Preferably, they can each have a diameter of between 1.2 and 1.5 cm and even more preferably a diameter of 13.7 mm. These diameters allow easy bending of the arms of the emitter. The emitters can be dimensioned identically or differently.

The light exit slit can be around 8 mm wide. It can extend along the entire length of the emitter. The emitter diameter can be approximately 13 mm. The heating coil can have a diameter of approximately 2 mm. The light exit slit is narrower than in the prior art. The small values for the emitter diameter, the light exit slit and/or the heating coil diameter allow better focusing of the radiation onto as narrow a line as possible along the plastic film in the laminated glass.

The angled ends or arms of adjacent emitters are in direct contact with each other. The angled ends of adjacent emitters can also be at a (small) distance from each other, for example maximally 1 cm, maximally 5 mm or maximally 2 mm.

The present disclosure also relates to a glass cutting device for processing (dividing) laminated glass panel of different widths with an emitter system that comprises at least three emitters. The emitter system is arranged in a glass cutting device. The emitter system is preferably the emitter system described above.

In one form of embodiment the glass cutting device comprises a control unit, which is configured to switch only one or several of the total number of emitters on and off and/or to regulate their strength. Precisely one, precisely two or precisely three of the emitters could be switched on for example. In one embodiment the glass cutting device comprises a certain number of single and/or individually controllable emitters.

In one form of embodiment, the glass cutting device also comprises a sensor which is configured to record the width of a laminated glass panel to be processed and to provide this width as input for the control unit, for example, for controlling the appropriate number of emitters.

In one form of embodiment the glass cutting device further comprises a cutting device for cutting laminated glass panels of different widths along a cutting axis parallel to a common longitudinal axis of elongated emitters of the emitter system.

The glass cutting device can also comprise a conveying device for conveying a laminated glass panel relative to the emitters.

The glass cutting device can comprise a second emitter system which is arranged on the side of a laminated glass panel to be processed opposite the first (previously described) emitter system.

Preferably, no active cooling, such as, for example, a fan for cooling the emitter or the periphery of the emitter is envisaged in the glass cutting bench. One of the reasons that cooling can be dispensed with is that, thanks to the relatively high power densities of the emitters, the irradiation duration is shorter than with conventional emitters. Without cooling, the construction of the glass cutting bench is simpler and less energy is required.

The present disclosure also relates to a manufacturing method for an emitter system for the irradiation of laminated glass panels of different widths. The manufacturing method comprises the following steps: provision of at least three elongated emitters and arranging the emitters in a glass cutting device one behind the other on a common longitudinal axis.

The elongated emitters each have two ends, which are angled in relation to the common longitudinal axis.

The present disclosure also relates to a use of the emitter system described above for the irradiation of laminated glass panels of different widths.

Use of the emitter system and processing of a laminated glass panel can take place as follows:
a) positioning of the laminated glass panel on the glass cutting bench,
b) cutting the upper glass sheet,
c) cutting the lower glass sheet, and
d) softening and/or melting the film.

More particularly, the processing takes place in the sequence (a), then (b) and (c), wherein, in particular, initially (b) and then (c) take place, then (d) is carried out. Alternatively, steps (b) and (c) can been carried out overlapping in time, more particularly simultaneously. Cutting of the glass sheets in steps (b) and (c) takes place in a joint scoring plane perpendicular to the plane of the glass sheets. The softening and/or melting of the film takes place through heating by way of the emitter system, preferably along the scoring plane, preferably focussed on the area of the scoring plane. The laminated glass panel can then be divided into several laminated glass panel sections in that oppositely directed tensile forces act on the laminated glass panel sections to separate the laminated glass panel along the scoring plane. If the film only softens along the scoring and has not been fully melted, the film can be cut through.

Another possibility is scoring the upper glass sheet and the lower glass sheet of the laminated glass panel, alternating bending or kinking along the score line in order to break the scored glass sheets completely, and finally dividing or cutting through the film. The film can be heated and softened to such an extent by the emitters of the emitter system that a gap can be produced by mechanically pulling apart the laminated glass panel sections and the film can be cut through along the gap by way of a cutting knife, for example.

Further features, advantages and application possibilities of the present disclosure are set out in the following description, the examples of embodiments and the figures. All described and/or visually shown features can be combined with each other irrespective of their depiction in the individual figures, sentences or paragraphs. In the figures, the same reference numbers denote identical or similar objects.

### BRIEF DESCRIPTION OF THE FIGURES

FIGS. 1a and 1b show an emitter system for the irradiation of laminated glass panels of different widths and a glass cutting device with such an emitter system;

FIGS. 2a to 2e show several views of a single emitter of the emitter system shown in FIGS. 1a and 1b;

FIG. 3 shows a schematic view of the glass cutting device for processing laminated glass panels of different widths; and

FIG. 4 shows a schematical view of a manufacturing method for an emitter system for the irradiation of laminated glass panels of different widths.

### DETAILED DESCRIPTION OF THE EXAMPLES OF EMBODIMENTS

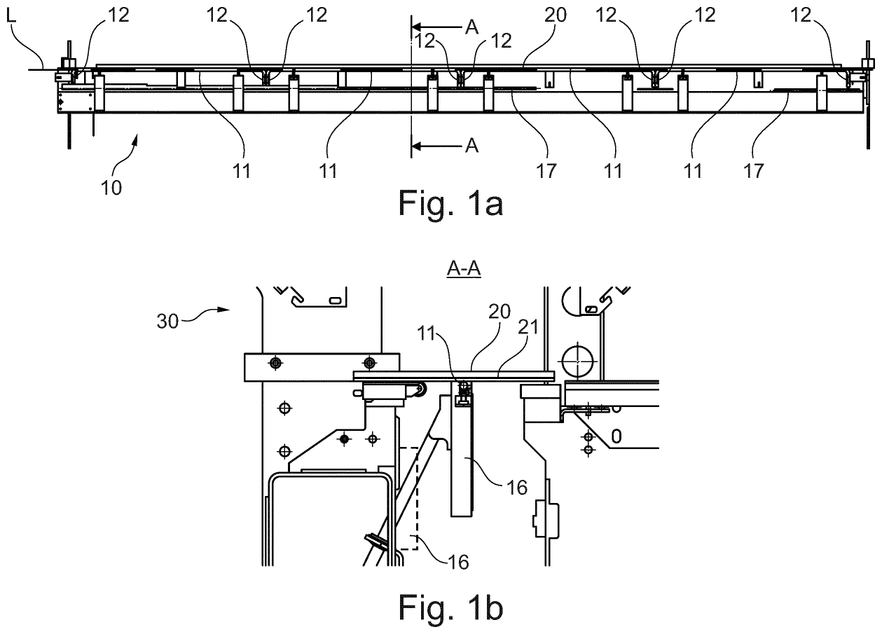

FIGS. 1a and 1b show an emitter system 10 for the irradiation of laminated glass panels 20 of different widths and a glass cutting device 30 with such an emitter system 10. FIG. 1b is a cross section taken along the line A-A of FIG. 1a. As shown, the emitter system 10 comprises four elongated emitters 11. The term “elongated” means that the emitters 11 are longer than they are wide. More particularly, the length of an elongated emitter is at least ten times greater than the emitter diameter. The elongated emitters 11 are arranged one behind the other on a common longitudinal axis L. The emitters 11 each have two ends 12, which are angled in relation to the common longitudinal axis L so that the power connections at the ends 12 are not in the plane of the emitter 11. FIGS. 1a and 1b show a single laminated (safety) glass panel 20 consisting of two glass plates with a plastic film 21 interspersed between them.

The emitters 11 can be infrared (IR) emitters, which emit shortwave infrared radiation in order to heat, soften and possibly cut through the plastic film 21. The emitters 11 are arranged geometrically one after the other in series and can be activated and controlled independently of each other, i.e., they are electrically connected in parallel. Each individual emitter 11 has a length which is smaller than the width of the laminated glass panel 20 to be irradiated. The emitters 11 are of equal length. The emission direction of the emitters 11 is essentially perpendicular to the laminated glass panel 20 to be irradiated. The emitters 11 are supplied with energy via an energy supply 17.

As four emitters 11 are arranged along a common longitudinal axis L, it is possible that only as many emitters 11 are used as is necessary for the current laminated glass panel width. If a narrower laminated glass panel 20, which is not shown, were being processed, precisely one, precisely two or precisely three of the four emitters 11 could be switched on for example. In this way, energy and time can be saved. The high number of emitters 11 makes it possible to reduce the length of the individual emitters 11. Shorter emitters 11 are considerably easier to use than longer ones.

The two ends 12 of each of the emitters 11 are angled by 90° in relation to the common longitudinal axis L. In this way, the power connections are moved out of the plane of the emitters 11 so that the power connections are located outside the direct irradiation and remain cooler, which increases their service life. The angled ends 12 or arms of adjacent emitters 11 are in direct contact with each other.

The emitters 11 each have a diameter of approximately 13.7 mm. The power density of the emitter system 10 is between 30 and 50 W/cm2. Due to the power density of the emitter system 10, a shorter irradiation duration can be made possible, which reduces heating of and thermal damage to the plastic film 21 remaining in the surrounding laminated glass.

The emitters 11 are held in a holder 16, which, as shown in FIG. 1b, can be moved between a heating position (continuous line) and a parking position (dashed line).

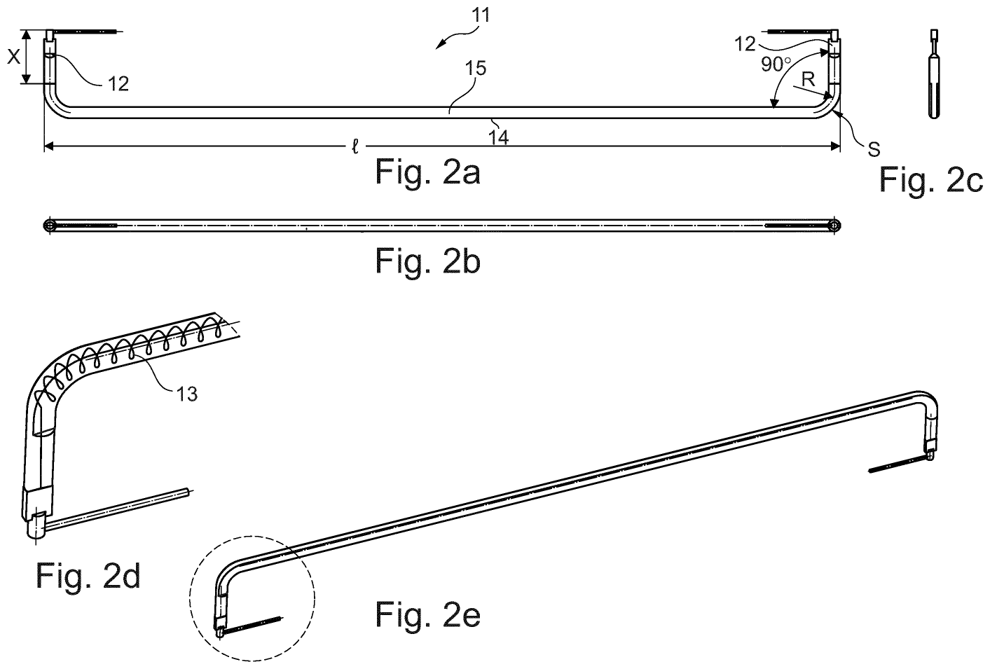

FIGS. 2a to 2e show several views of a single emitter 11 of the emitter system 10. More specifically, FIG. 2a is a side view, FIG. 2b is a top view, FIG. 2c is an end view, FIG. 2e is a perspective view, and FIG. 2d is an expanded view of the circled portion at the end of FIG. 2e. The emitter 11 has a length of 950 mm from the middle point of one electrical connection to the middle point of the other electrical connection. The overall length of the emitter 11 from the outermost periphery of one arm to the outermost periphery of the other arm is essentially 964 mm. The length of the arm between the free end of the arm and the outer diameter in the elongated part of the emitter can be around 107 mm, for example.

The emitter 11 is a round tube emitter made of quartz with a heating coil 13 inside it. The heating coil 13 or filament is suitable for heating, softening and, if necessary, dividing the plastic film 21 of the laminated glass panel 20.

The two ends 12 or arms of the emitter 11, which are angled by approximately 90°, have a bending radius in relation to the longitudinal axis L of the emitter 11. The bending radius is, for example, around R25 on both sides. Both ends 12 of the emitter 11 each form an electrical connection in the form of a wire, possibly with an insulating section.

In the emitter 11, the heating coil 13 extends along the longitudinal axis L and beyond the vertex S of the two bending radii R. The heating coil 13 therefore ends in the emitter 11 after the two vertices S but still before the ends of the arms 12 of the emitter 11. The free ends of the arms or ends 12 of the emitter 11 therefore do not comprise heating coils 13 and are therefore unheated or at least not directly heated. The incandescent area of the heating coil 13 only begins at a certain distance x of, for example, around 75 mm, from the unheated arm ends 12 of the emitter 11. The total heated length can be approximately 979 mm for example. By “pulling in” the heating coil 13 into the bending radii R and beyond, homogenous irradiation of the component along the plurality of emitters 11 is achieved and possibly inhomogeneity in the transition between two adjacent emitters 11 is reduced or avoided.

The emitter 11 comprises a light exit slit 14 and a reflector 15. The light exit slit 14 extends over the entire length l of the emitter 11 and serves to emit radiation in the direction of the laminated glass panel 20. The reflector 15 reflects radiation emitted by the emitter 11 in the direction of the reflector 15 back in the direction of the light exit slit 14. The reflector 15 is a gold coating on the periphery of the emitter 11, wherein only the light exit slit 14 is left free. The reflector 15, for example in the form of a gold coating, can extend along the longitudinal axis L and beyond the bending radii R of the angled ends 12 of the emitter 11. The reflector 15 can also extend beyond the heated length, i.e., beyond the heating coils 13. For example, at each end, the reflector 15 can extend approximately another 10 mm beyond the heated length. The reflector 15 enables focusing of the radiation onto as narrow a line as possible along the plastic film 21 in the laminated glass panel 20 and thereby produces as narrow a melting area as possible. In this way, the reflector 15 permits a further reduction in the power density of the emitter 11. In addition, the reflector 15 prevents or reduces heating of the emitter periphery and the surrounding components of the glass cutting device 30.

In the case of an emitter diameter of around 13.87 mm, the light exit slit 14 can be around 8 mm wide. It can extend along the entire length of the emitter 11. The heating coil 13 can have a diameter of approximately 2 mm. The light exit slit 14 is narrower than in the prior art. The small values possible for the emitter diameter, the light exit slit 14 and/or the heating coil diameter allow better focusing of the radiation onto as narrow a line as possible along the plastic film 21 in the laminated glass panel 20.

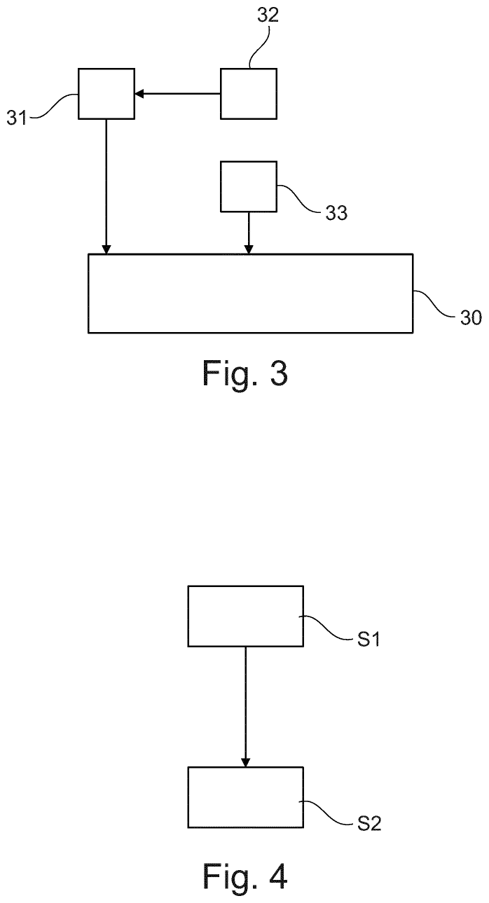

FIG. 3 shows a schematic view of the glass cutting device 30 for processing laminated glass panels 20 of different widths. The glass cutting device 30 can comprise the above-described emitter system 10 with a plurality of emitters 11.

The glass cutting device 30 comprises a control unit 31, which is configured to switch only one or several of the total number of emitters 11 on and off. The individual emitters 11 and/or their heating coils 13 are controlled and switched on and off independently of each other. The glass cutting device 30 also comprises a sensor 32 which is configured to record the width of a laminated glass panel 20 to be processed and to provide this width as input for the control unit 31. The component and its dimensions can be identified by RFID tag, for example, or can be measured by a laser for instance. As a function of this capability, the control unit 31 can switch an appropriate number and selection of emitters 11 on and off, or regulate their strength.

The glass cutting device 30 further comprises a cutting device 33 for cutting laminated glass panels 20 of different widths along a cutting axis parallel to a common longitudinal axis L of the elongated emitters 11 of the emitter system 10.

FIG. 4 shows a schematic view of a manufacturing method for an emitter system 10 for the irradiation of laminated glass panels 20 of different widths. The manufacturing method comprises the following steps: provision of at least three elongated emitters 11 (S1) and arrangement of the emitters 11 one behind the other on a common longitudinal axis L (S2).

The elongated emitters 11 each have two ends 12, which are angled in relation to the common longitudinal axis L.

It is additionally pointed out that “comprising” and “having” do not rule out other elements or steps, and “a” or “an” do not rule out a plurality. It is also pointed out that features or steps which have been described with reference to the above examples of embodiments can also be used in combination with other features or steps of other examples of embodiments described above.

Further forms of embodiments are described below with reference to element numbers in parenthesis as illustrated in the figures:

1. An emitter system (10) for the irradiation of laminated glass panels (20) of different widths, which comprises a plurality, in particular at least three, elongated emitters (11), wherein the elongated emitters (11) are arranged one behind the other on a common longitudinal axis (L), and wherein the elongated emitters (11) each have two ends (12), which are angled in relation to the common longitudinal axis (L).

2. Emitter system (10) according to embodiment 1, wherein the emitters (11) each have a heating coil (13) for heating and/or softening a plastic film (21) inside a laminated glass panel (20).

3. Emitter system (10) according to embodiment 1 or 2, wherein the ends (12) of the emitter (11) angled in relation to the common longitudinal axis (L) have a bending radius (R) and the heating coils (13) in the emitters (11) extend along the common longitudinal axis (L) and beyond the vertices (S) of the bending radii (R).

4. Emitter system (10) according to any one of the above embodiments, wherein the emitter system (10) comprises at least 3 and/or at most 10 elongated emitters (11), preferably at least 6 and/or at most 8 elongated emitters (11).

5. Emitter system (10) according to any one of above embodiments, wherein the emitters (11) have a length (C.) of at least 200 mm and/or at most 1,200 mm.

6. Emitter system (10) according to any one of the above embodiments, wherein the plurality of elongated emitters (11) are each of equal length.

7. Emitter system (10) according to any one of the above embodiments, wherein the power density of the emitter system (10) is between 30 and 50 W/cm2, preferably between 40 and 50 W/cm2.

8. Emitter system (10) according to any one of the above embodiments, wherein at least one of the emitters (11) comprises a light exit slit (14) and a reflector (15), wherein the reflector (15) reflects radiation emitted by the emitter (11) in the direction of the reflector (15) back in the direction of the light exit slit (14).

9. A glass cutting device (30) for processing laminated glass panels (20) of different widths with an emitter system (10), more particularly according to any one of the above embodiments, wherein the emitter system (10) comprises at least three emitters (11).

10. Glass cutting device (30) according to the above embodiments also comprising a control unit (31) which is configured to switch individual, more particularly only one or several, of the total number of emitters (11) on and off.

11. Glass cutting device (30) according the above embodiments, further comprising a sensor (32) which is configured to record the width of a laminated glass panel (20) to be processed and to provide this width as input for the control unit (31).

12. Glass cutting device (30) according to any one of embodiments 9 to 11, further comprising a cutting device (33) for cutting laminated glass panels (20) of different widths along a cutting axis parallel to a common longitudinal axis (L) of the elongated emitters (11) of the emitter system (10).

13. Glass cutting device (30) according to any one of embodiments 9 to 12, wherein each individual emitter (11) has a length which is smaller than the width of a laminated glass panel (20) to be irradiated.

14. A manufacturing method for an emitter system (10) for the irradiation of laminated glass panels (20) of different widths, comprising the following steps:
provision of a plurality, more particularly at least three, elongated emitters (11), and
arrangement of the emitters (11) one behind the other on a common longitudinal axis L,
wherein the elongated emitters (11) each have two ends (12), which are angled in relation to the common longitudinal axis (L).

15. Use of an emitter system (10) according to any one of the above embodiments for the irradiation of laminated glass panels (20) of different widths.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

1. An emitter system for the irradiation of laminated glass panels of different widths, which comprises a plurality of elongated emitters arranged one behind the other on a common longitudinal axis, wherein the elongated emitters each have two ends which are angled in relation to the common longitudinal axis, and wherein the emitter system is configured to be arranged in a glass cutting device.

2. The emitter system according to claim 1, wherein the emitters each have a heating coil for heating and/or softening a plastic film inside a laminated glass panel.

3. The emitter system according to claim 2, wherein the ends of each emitter angled in relation to the common longitudinal axis have a bending radius with a vertex and the heating coils in the emitters extend along the common longitudinal axis and beyond the vertices of the bending radii.

4. The emitter system according to claim 1, wherein the emitter system comprises at least 3 and/or at most 10 elongated emitters.

5. The emitter system according to claim 1, wherein the emitters have a length of at least 200 mm and/or at most 1,200 mm.

6. The emitter system according to claim 1, wherein the plurality of elongated emitters are all of equal length.

7. The emitter system according to claim 1, wherein the power density of the emitter system is between 30 and 50 W/cm².

8. The emitter system according to claim 1, wherein at least one of the emitters comprises a light exit slit and a reflector, wherein the reflector reflects radiation emitted by the emitter in the direction of the reflector back in the direction of the light exit slit.

9. A glass cutting device for processing laminated glass panels of different widths with an emitter system according to claim 1, wherein the emitter system is arranged in the glass cutting device comprises at least three emitters.

10. The glass cutting device according to claim 9, further comprising a control unit which is configured to switch individual emitters on and off.

11. The glass cutting device according to claim 10, further comprising a sensor which is configured to record the width of a laminated glass panel to be processed and to provide this width as input for the control unit.

12. The glass cutting device according to claim 9, further comprising a cutting device for cutting laminated glass panels of different widths along a cutting axis parallel to the common longitudinal axis of the elongated emitters of the emitter system.

13. The glass cutting device according to claim 9, wherein each individual emitter has a length which is smaller than the width of a laminated glass panel to be irradiated.

14. A manufacturing method for an emitter system for the irradiation of laminated glass panels of different widths, comprising the following steps:
providing a plurality of elongated emitters, and
arranging the emitters in a glass cutting device one behind the other on a common longitudinal axis,
wherein the elongated emitters each have two ends, which are angled in relation to the common longitudinal axis.

15. A method of using the emitter system according to claim 1 for the irradiation of laminated glass panels of different widths.

16. An emitter system for the irradiation of laminated glass panels of different widths, the system comprising:
at least three elongated emitters arranged one behind the other on a common longitudinal axis, wherein the elongated emitters each have two ends which are angled in relation to the common longitudinal axis and which have a bending radius with a vertex;
a heating coil disposed in each of the emitters for heating and/or softening a plastic film inside a laminated glass panel, each of the heating coils extending along the common longitudinal axis and beyond the vertices of the bending radii; and
a light exit slit and a reflector associated with at least one of the emitters, wherein the reflector reflects radiation emitted by the emitter in the direction of the reflector back in the direction of the light exit slit,
wherein the emitter system is configured to be arranged in a glass cutting device.

17. The emitter system according to claim 16, wherein the emitter system comprises at most 10 elongated emitters.

18. The emitter system according to claim 16, wherein the emitters have a length of at least 200 mm and/or at most 1,200 mm.

19. The emitter system according to claim 16, wherein the plurality of elongated emitters are all of equal length.

20. The emitter system according to claim 16, wherein the power density of the emitter system is between 30 and 50 W/cm².
